(19) United States
(12) Patent Application Publication
(10) Pub. No.: US 2010/0225078 A1
(43) Pub. Date: Sep. 9, 2010

(54) Container for Soiled Clothing

(75) Inventor: Thomas K. Bragg, Sylvania, GA (US)

Correspondence Address: J. BENNETT MULLINAX, LLC, P. O. BOX 26029, GREENVILLE, SC, 29616-1029, US

(73) Assignee: Washington Savannah River Company LLC, Aiken, SC (US)

(21) Appl. No.: 11/922,534

(22) PCT Filed: Dec. 1, 2007
(86) PCT No.: PCT/US2007/024727

§ 371 Date: Dec. 19, 2007

Related U.S. Application Data
(60) Provisional application No. 60/872,189, filed on Dec. 1, 2006.

(51) Int. Cl. B62B 1/10

(52) U.S. Cl. 280/47.26

(57) ABSTRACT

A container (10) for receiving contaminated clothing from an industrial environment such as a radiation work area is provided. The container (10) provides for a telescopic handle (30) and a spaced frame (20) extending around the container (10) which workers can grasp to maintain balance while changing into and out of protective clothing. The container (10) is preferably made of a metal which provides sufficient stability and rigidity for workers to brace themselves. The container (10) has a fittable lid (14) which provides for a telescopic handle (30) which can be used to pivot the lid (14) as well as providing a handheld support for workers.

### RELATED APPLICATIONS

This application claims the benefit of U.S. Application Ser. No. 60/872,189, filed on 1 Dec. 2006, and which is incorporated herein by reference.

### STATEMENT AS TO RIGHTS TO INVENTIONS MADE UNDER FEDERALLY SPONSORED RESEARCH AND DEVELOPMENT

This invention was made with Government support under Contract No. DE-AC0996-SR18500 awarded by the United States Department of Energy. The Government has certain rights in the invention.

### FIELD OF THE INVENTION

This invention is directed towards a container for receiving contaminated clothing for use at Step Off Pad areas. In many industrial environments, such as a radiation area, workers must exit at a Step Off Pad (SOP) to remove any protective clothing and place it into a clothing container. Any contaminated waste other than clothing should also be directed into a separate waste container.

### BACKGROUND OF THE INVENTION

Contaminated clothing containers for use at SOPs are commercial trash containers upon which a laundry bag or waste bag is placed for the receipt of clothing or other waste. The prior art containers do not lend themselves to providing any assistance to workers who need to remove contaminated clothing. The conventional handles and lids on such containers are also not well suited for the unique demands of a SOP within a radiologically contaminated area.

Accordingly, there remains room for improvement and variation within the art.

### SUMMARY OF THE INVENTION

It is one aspect of at least one of the present embodiments to provide a sturdy and stable container for holding removed protective clothing that helps workers maintain their balance while changing out of protective clothing.

It is a further aspect of at least one embodiment of the present invention to provide a protective clothing receptacle which is portable, weather proof, and easy to decontaminate.

It is a further aspect of at least one embodiment of the present invention to provide for a receptacle for receiving used protective clothing which can be easily transported by a single user, can be used to steady a worker while changing clothes, has a lid with a stop mechanism to facilitate easy closure, has dimensions that are compatible with standard size commercial laundry bags and has sufficient dimensions and capacity such that a single operator can easily and safely move the wheeled container when fully loaded with contaminated clothing.

These and other aspects of the invention are provided by a container for receiving contaminated clothing comprising: a compartment defining an interior volume; a lid adapted for engaging the compartment, the lid capable of being operatively disposed between a closed position and an open position relative to the compartment; a frame, supported by the compartment and extending around an exterior of the compartment, the frame having at least one rear portion positioned a spaced distance from a rear of the lid and the compartment; at least one hinge connecting at least one rear portion of the frame to the lid; a handle attached to the lid, the handle extending outwardly from the lid at least about 30 cm from an edge of the lid; a pair of wheels positioned along a rear of the compartment; and wherein the lid, when in an open position, will engage a portion of a rear wall of the compartment, thereby preventing the lid from further movement in a rear direction; and, wherein the at least one hinge further defines a stop member for limiting movement of the lid beyond about a 90° angle relative to the compartment and the at least one rear portion of the frame extends above the horizontal plane of the lid when the lid is in a closed position.

Further, the handle is a telescopic handle and is attached to an upper surface of the lid or to a front portion of the lid and the compartment nests within a cavity defined by an undersurface of the lid and the frame defines a rear portion which extends a spaced distance from a rear of the lid and a rear wall of the compartment.

These and other features, aspects, and advantages of the present invention will become better understood with reference to the following description and appended claims.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings.

FIG. 1 is a perspective view of one exemplary embodiment of the present invention.

FIG. 2 is a perspective view similar to FIG. 1 and showing additional details in partial section.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

Conventional containers used for receiving used radiological protective clothing make use of modified commercial trash containers. Such trash containers provide no support mechanism to assist workers in the removal of protective clothing. In addition, the free swinging lids on such commercial embodiments can frequently unbalance an empty or near empty container. Likewise, closing a free swinging lid can be difficult when there is no counter balancing load within the interior of the commercial trash container.

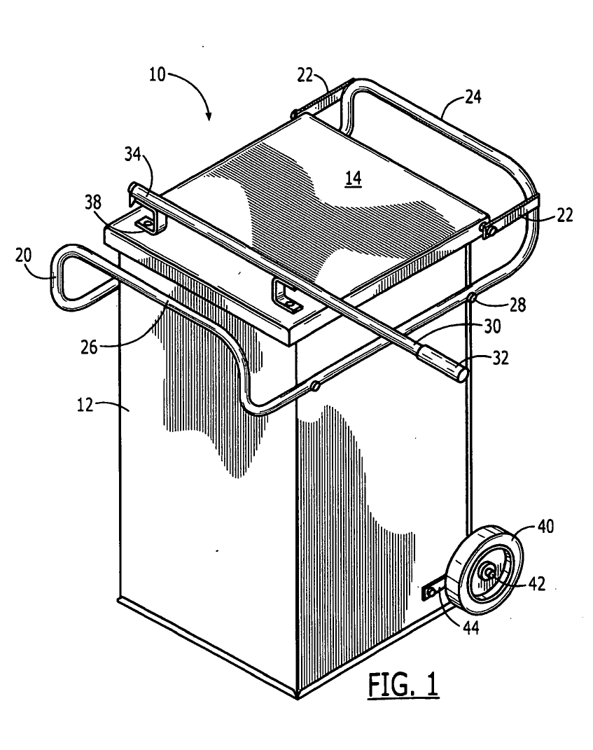

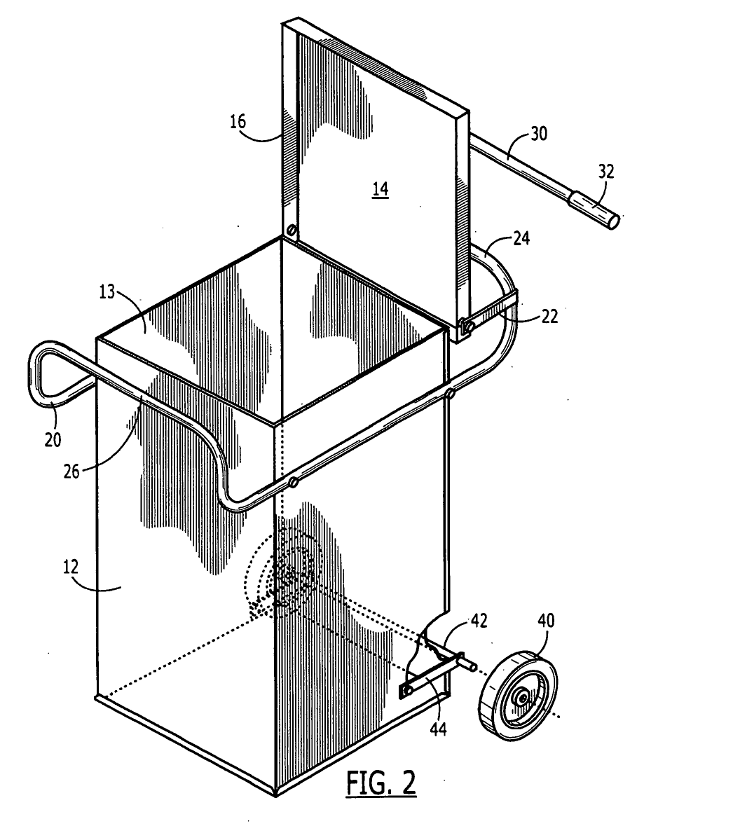

As best seen in reference to FIGS. 1 and 2, the container 10 comprises a compartment 12 having an upper lid 14, lid 14 having slightly greater dimensions than compartment 12. A lower surface of lid 14 defines a flange 16 which projects downwardly and extends around a perimeter of lid 14. In this manner, the upper rim of compartment 12 nests within flange 16 and lid 14. Attached to compartment 12 is a frame 20 having a front portion 26 and a rear portion 24 each of which extend slightly above the container 10 and lid 14 when lid 14 is in a closed configuration as seen in FIG. 1. Lid 14 is attached by a pair of hinges 22 to the portion of rear frame 24. Preferably hinges 22 are connected to flange 16 along opposite sides of lid 14. Frame 20 can be attached to the compartment 12 via any conventional mounting hardware suitable for the respective materials. Such attachments may include the use of threaded fasteners 28 or welding of the frame 20 to the compartment 12.

Lid 14 and compartment 12 may be provided from stainless steel. The use of stainless steel provides for a sturdy construction that may be easily cleaned and decontaminated while maintaining a weight that still permits easy portability of the container. On a lower rear of compartment 12, there are a pair of wheels provided which are connected by an axle 42 which, as illustrated, extends along an exterior of compartment 12. A pair of mounting brackets 44 are used to attach and support the axle 42 and wheel 40 to the compartment 12.

An upper surface of lid 14 supports thereon a handle 30 which comprises a handle tube 34, an extension 36, a terminal end of extension 36 defining a grip 32. The interplay between extension 36 and handle tube 34 is such that member 36 may telescope in and out of the interior of the handle tube 34. The telescopic nature of the handle 30 allows for the telescopic end of extension 36 to extend outwardly along the side of the container. When so extended, the handle provides a gripping surface 32 that an individual can grasp and use to steady, himself while removing contaminated clothing. Preferably, handle 30, handle tube 34, and extension 36 are made of an inert metal, such as stainless steel.

As seen in reference to FIG. 2, lid 14 may be pivoted freely to at least a 90° angle to provide for access to the interior 13 of compartment 12. Preferably, hinges 22 may be attached to the flange 16 of lid 14 in which the attachment site of lid 14 provides a detent, stop member, or other blocking mechanism that will retain lid 14 in the illustrated open, upright configuration. As further seen in reference to FIG. 2, by providing a limited amount of spacing between the lid and the rear wall of the compartment 12, the engagement between the rear container wall and bottom rear edge of the raised lid can also limit the range of motion the lid can travel. As seen in FIGS. 1 and 2, the rear edge of lid 14 extends beyond the rear compartment wall to facilitate the interengagement of the rear container wall and the bottom rear edge of lid 14. Alternatively, lid 14 may rest against a portion of rear frame 24 which may also serve as a stop member to prevent the lid from free swinging on the container. Providing some type of stop member or other blocking mechanism with respect to the lid prevents the container from becoming unbalanced by a free swinging lid and also allows the handle 30 to be engaged while the lid is in an open configuration. As such, workers removing contaminated clothing can be supported by grasping handle 30 as well as front frame 26 and rear frame 24.

While the overall size, shape, and dimensions of the container 10 and compartment 12 are not critical, it is advantageous to conform the dimensions to accommodate standard size commercial laundry bags. Such laundry bags can be attached to or suspended within the interior volume 13 of compartment 12 by any conventional means including clips, hooks, or other hardware (not illustrated). As seen in FIG. 2, when lid 14 is in an upright, open position, there is sufficient clearance between the lid and the upper rim of compartment 12 such that placement of a laundry bag or liner along the rim of compartment 12 may be accomplished. While a rectangular container 10 is illustrated, other shapes, including round containers may be used.

The container 10 may be fabricated from a number of different materials. A stainless steel container, for instance, may be constructed having a weight of about 15 to 20 kilograms which provides stability when workers are using the various handles and bars to assist when removing protective clothing. While stainless steel is extremely durable and can be easily decontaminated, it is also recognized that other materials including fiberglass, plastic, other metals, or similar materials may be used to construct a waste container for protective clothing according to the details and disclosures set forth herein. One advantage of stainless steel or other metal is that the weight of the container is sufficient to resist being blown over by wind gusts for applications where the SOP may be outdoors.

While protective clothing removal occurs at contaminated radiation areas, the container also has advantages at other work sites where contaminated clothing must be removed and processed. For instance, surgical suites in hospitals, chemical processing facilities, food processing facilities, industrial waste collection, industrial cleaning, and bulk chemical transfer and handling operations are all representative environments where protective clothing is typically worn and must be collected from workers as they exit the work site. Many employers in industrial fields of technology provide protective uniforms, coveralls, and other protective outer wear for which the company is responsible for cleaning and maintaining. Providing the clothing receptacle as set forth herein at convenient locations for workers facilitates the collection of clothing and does so in a manner that allows the workers to safely remove the clothing and do so in a more expedient and efficient manner.

An additional advantage of a stainless steel or other heavy duty construction material is that a clean/decontaminated container can be used to transport protective clothing to a work area. For instance, a metal bracket suspended across the opening of compartment 12 can be used to hang protective gear. Subsequently, at the end of a shift, the same container can be used to receive the contaminated clothing.

The present invention can also be used in the hotel/motel industry as a safer alternative to conventional laundry carts. The waste container is easily transported and can be used to collect and transport soiled bedding, used towels, and other items that require laundering. Safety guidelines for the safe handling of used linens and towels dictate that workers need to protect themselves from such items using protective gear. The present invention allows for the materials to be received in the container and easily transported without exposure to other workers, hotel guests, etc. The present invention is also conducive to a laundry receptacle for the entertainment industry at locations such as pools and health clubs. Such facilities frequently provide towels for use by their patrons and guests which are returned to designated receptacles. The present invention provides a receptacle that is easy to use, holds a generous supply of soiled items, and may be transported to an onsite location if desired without additional worker or patron exposure to the soiled items.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention.

1. A container for receiving contaminated clothing comprising:
a compartment defining an interior volume;
a lid, adapted for engaging said compartment, said lid capable of being operatively disposed between a closed position and an open position relative to said compartment;
a frame, supported by said compartment and extending around an exterior of said compartment, said frame having at least one rear portion positioned a spaced distance from a rear of said lid and said compartment;
at least one hinge connecting said at least one rear portion of said frame to said lid;
a handle attached to said lid, said handle extending outwardly from said lid at least about 30 cm from an edge of said lid; and,
a pair of wheels positioned along a rear of said compartment.

2. The container according to claim 1 wherein said lid when in an open position, will engage a portion of a rear wall of said compartment, thereby preventing the lid from movement in a rear direction.

3. The apparatus according to claim 1 wherein said at least one hinge further defines a stop member for limiting movement of said lid beyond about a 90° angle relative to said compartment.

4. The apparatus according to claim 1 wherein said at least one rear portion of said frame extends above the horizontal plane of said lid when said lid is in a closed position.

5. The apparatus according to claim 1 wherein said handle is a telescopic handle.

6. The container according to claim 1 wherein said handle is attached to an upper surface of said lid.

7. The apparatus according to claim 1 wherein said handle is attached to a front portion of said lid.

8. The apparatus according to claim 1 wherein said compartment nests within a cavity defined by an undersurface of said lid.

9. The apparatus according to claim 1 wherein said frame defines a rear portion which extends a spaced distance from a rear wall of said lid and a rear wall of said compartment.
